(19) United States
(12) Patent Application Publication
(10) Pub. No.: US 2015/0242160 A1
(43) Pub. Date: Aug. 27, 2015

(54) MEMORY SYSTEM, CONTROL METHOD OF MEMORY SYSTEM, AND CONTROLLER

(71) Applicant: Kabushiki Kaisha Toshiba, Minato-ku (JP)

(72) Inventor: Nobuyuki MYOUGA, Iruma-shi (JP)

(73) Assignee: Kabushiki Kaisha Toshiba, Minato-ku (JP)

(21) Appl. No.: 14/330,131

(22) Filed: Jul. 14, 2014

Related U.S. Application Data
(60) Provisional application No. 61/944,922, filed on Feb. 26, 2014.

(51) Int. Cl. G06F 3/06

(52) U.S. Cl. CPC G06F 3/0659; G06F 3/0604; G06F 3/0679; G06F 3/0656

(57) ABSTRACT

According to one embodiment, a memory system includes a command table that stores therein a write command received from a host, a nonvolatile memory that stores therein write data, and a response setting circuit that creates a management table that corresponds to the write command in the command table. Furthermore, the memory system includes a transport layer that generates the response frame based on the management table and a physical layer that transmits the response frame to the host.

### CROSS-REFERENCE TO RELATED APPLICATIONS

This application is based upon and claims the benefit of priority from U.S. Provisional Application No. 61/944,922, filed on Feb. 26, 2014; the entire contents of which are incorporated herein by reference.

### FIELD

Embodiments described herein relate generally to a memory system, a control method of a memory system, and a controller.

### BACKGROUND

Generally, in a memory system (a storage device) such as an HDD (Hard Disk Drive) or an SSD (Solid State Drive), a write/read speed to or from a nonvolatile storage medium (such as a hard disk or a NAND flash memory) is slower than a write/read speed to or from a host I/F. Accordingly, such a memory system, a volatile memory such as an SDRAM (Synchronous Dynamic Random Access Memory) is used as a buffer (a cache).

When a memory system receives write data from a host, the memory system temporarily stores the data in a buffer. Thereafter, when writing of the data to a nonvolatile storage medium is completed, the memory system notifies the host the fact that the writing of the write data is completed.

In such a memory system, in order to realize high-speed processing of a write completion notification with respect to a write command, it has been desired that processing from a time when data writing to a nonvolatile storage medium is completed to a time when write completion is notified to a host is performed at a high speed.

### BRIEF DESCRIPTION OF THE DRAWINGS

FIG. 1 illustrates a configuration of a memory system according to a first embodiment;

FIG. 2 illustrates a configuration example of a data packet of write data;

FIG. 3 is an explanatory diagram of a write command protocol of a SAS;

FIG. 4 illustrates a SAS frame format;

FIG. 5 is an explanatory diagram of an IPTT in a SAS write command protocol;

FIG. 6 illustrates a configuration of an execution management table;

FIG. 7 illustrates a configuration of a host I/F control circuit including an execution management table;

FIG. 8 is a flowchart of a process procedure of a write command process in an SSD;

FIG. 9 is an explanatory diagram of a writing operation based on an execution management table;

FIG. 10 illustrates a configuration of a Write Response;

FIG. 11 is an explanatory diagram of a Write Response notification process;

FIG. 12 is an explanatory diagram of a transmission process of a RESPONSE frame in response to a Write Response;

FIG. 13 illustrates a configuration of a memory system according to a second embodiment;

FIG. 14 is an explanatory diagram of a FIFO in a host I/F control circuit according to the second embodiment; and

FIG. 15 illustrates a configuration of a memory system according to the third embodiment.

### DETAILED DESCRIPTION

In general, according to one embodiment, a memory system is provided. The memory system includes a command table that stores therein a write command received from a host and a nonvolatile memory that stores therein write data corresponding to the write command received from the host. Furthermore, the memory system includes a Response setting circuit that creates a management table that corresponds to the write command in the command table. Further, the memory system includes a Transport Layer that generates a response frame based on the management table and a Physical Layer that transmits the response frame to the host.

Exemplary embodiments of a memory system, a control method of a memory system, and a controller will be explained below in detail with reference to the accompanying drawings. The present invention is not limited to the following embodiments. In the following descriptions, a case where an example of the memory system (a storage device) is an SSD (Solid State Drive) is explained; however, the storage device can be other devices such as an HDD (Hard Disk Drive).

### First Embodiment

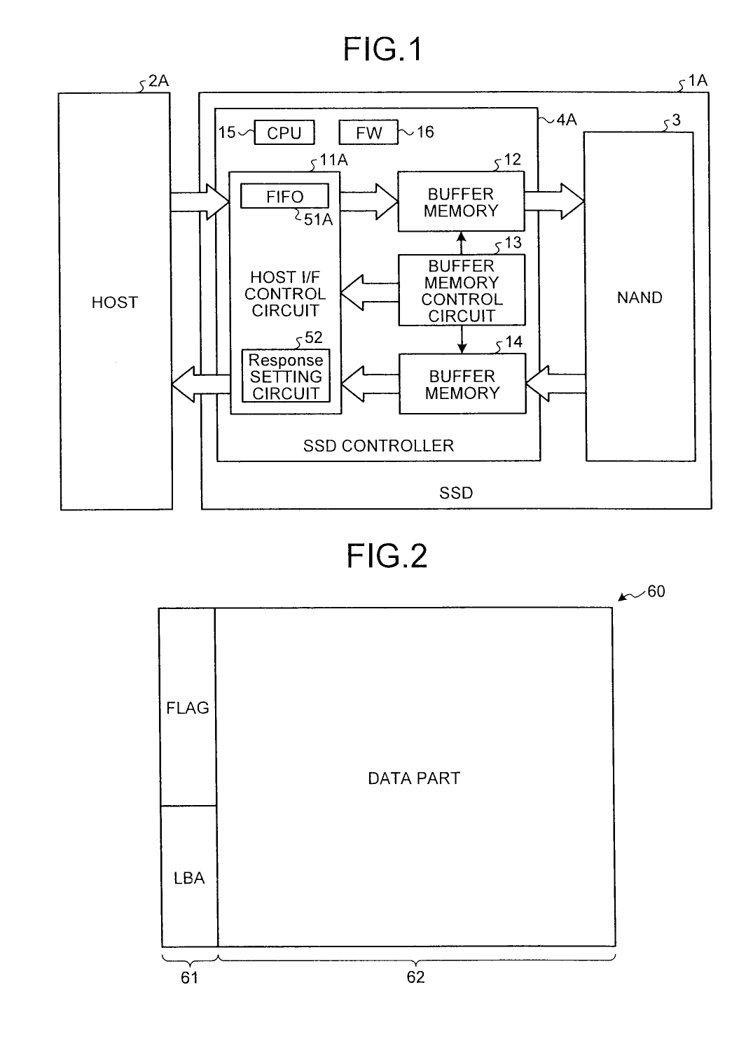

FIG. 1 illustrates a configuration of a memory system according to a first embodiment. An SSD 1A serving as a memory system is connected to a host (a host computer) 2A. When the SSD 1A receives a write command from the host 2A, the SSD 1A performs a data writing process (data storage) in response to the write command.

The SSD 1A includes an SSD controller 4A and a NAND (a NAND flash memory) 3. For example, the SSD controller 4A is constituted by a semiconductor chip such as an LSI (Large-Scale Integrated circuit).

The SSD controller 4A controls data transfer between the host 2A and the NAND 3 and the like. The SSD controller 4A includes a host I/F (interface) control circuit 11A, buffer memories 12 and 14, a buffer memory control circuit 13, a CPU 15, and a FW (firmware) 16.

The host I/F control circuit 11A is a circuit that controls a host I/F (not shown). The host I/F control circuit 11A temporarily stores data instructed by the host 2A to be written and the like in the buffer memory 12 and transfers data temporarily stored in the buffer memory 14 to the host 2A.

The host I/F control circuit 11A according to the present embodiment includes a Response setting circuit 52 and a FIFO 51A that stores therein information transmitted from the buffer memory control circuit 13 (a Write Response 80 explained later).

The Response setting circuit 52 is a circuit that monitors completion of data writing to the NAND 3 and generates information used when write completion is notified (execution management tables 103(#0) and 103(#1) for Response explained later).

The buffer memory 12 is a memory (a data write memory) that temporarily stores therein data instructed by the host 2A to be written. Data stored in the buffer memory 12 is written to the NAND 3 at a predetermined timing.

The buffer memory 14 is a memory (a data read memory) that temporarily stores therein data in the NAND 3 instructed by the host 2A to be read. Data stored in the buffer memory 14 is transferred to the host 2A at a predetermined timing.

The buffer memory control circuit 13 controls the buffer memories 12 and 14. The CPU 15 controls the overall SSD controller 4A. The FW 16 causes the host I/F control circuit 11A to perform a process of storing data instructed by the host 2A to be written to the NAND 3 and the like.

The NAND 3 stores therein write data (user data) specified by the host 2A and backs up management information managed in the SSD controller 4A and the like.

When the host 2A transmits a read command or a write command to the SSD 1A, the host 2A specifies an LBA (Logical Block Address) serving as a logical address. The LBA is a logical address in which a serial number from 0 is attached to a sector.

Write data that is transmitted from the host 2A and received by the SSD 1A is received by the host I/F control circuit 11A in the SSD controller 4A. The write data is loaded into the buffer memory 12 by the host I/F control circuit 11A per logical block managed by the host 2A. The write data in the buffer memory 12 is then written to the NAND 3 for each cluster serving as a unit of writing to the NAND 3.

While the SSD 1A includes a host I/F, illustrations of the host I/F are omitted in FIG. 1. The host I/F is arranged in the SSD controller 4A and connected to the host 2A and the host I/F control circuit 11A.

FIG. 2 illustrates a configuration example of a data packet of write data. To write data from the buffer memory 12 to the NAND 3, a header part (for example, 16 bytes) 61 is attached to a data part (write data) 62 loaded into the buffer memory 12. The header part 61 and the data part 62 constitute data of a logical block (a data packet 60). An LBA (for example, 6 bytes=48 bits) and various flags (for example, 10 bytes) are attached to the header part 61 and used at the time of control of writing to the NAND 3.

Next, a write command protocol between the host 2A and the SSD 1A is explained. A case where a host I/F is a SAS (Serial Attached SCSI) is shown below to explain the write command protocol.

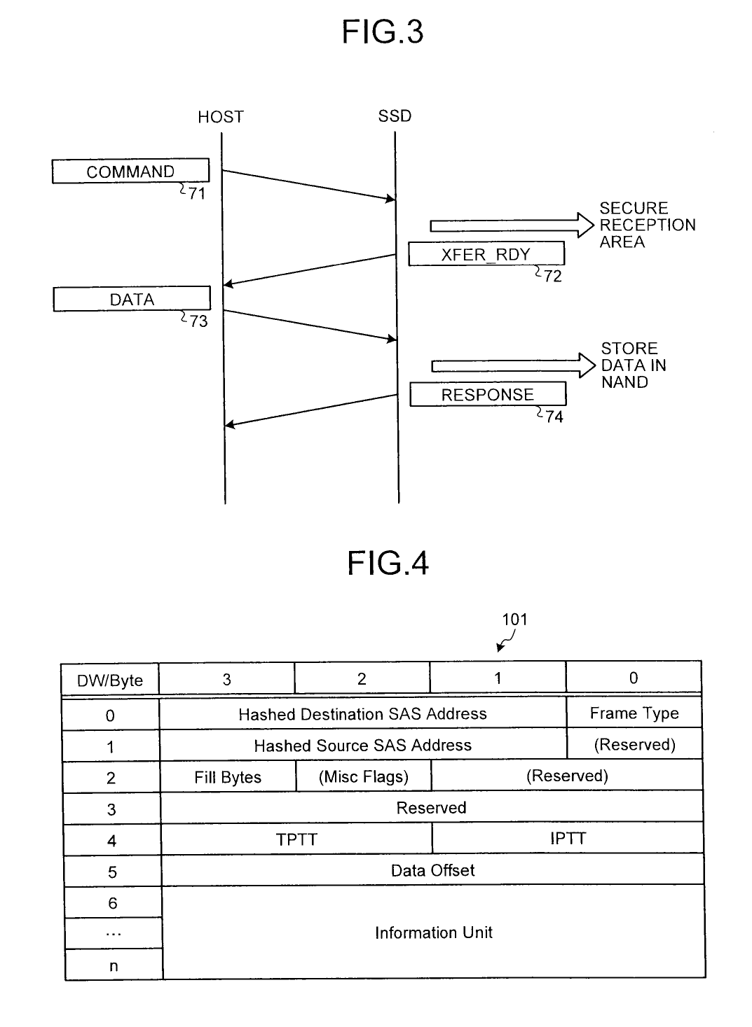

FIG. 3 is an explanatory diagram of a write command protocol of the SAS. In the SAS I/F protocol, a write command is issued to the SSD 1A by a COMMAND frame 71 transmitted by the host 2A.

The SSD 1A that receives the write command secures a reception area. Thereafter, when a preparation for receiving data is completed, the SSD 1A notifies the host 2A the fact that the preparation is completed by a XFER_RDY (transfer ready) frame 72.

The host 2A that receives the notification transmits write data to the SSD 1A by a DATA frame 73. The SSD 1A stores the received write data in the NAND 3 and then notifies the host 2A whether a process has ended successfully by a RESPONSE frame 74.

In the SAS I/F protocol, a command can be queued, and a Tag (an Initiator Port Transfer Tag, hereinafter “IPTT”) is given to a command by the COMMAND frame 71 when the command is issued. Therefore, the IPTT given by the COMMAND frame 71 is attached to the subsequent XFER_RDY frame 72, DATA frame 73, and RESPONSE frame 74, so that it is possible to identify to which command these frames are directed.

FIG. 4 illustrates a SAS frame format. A SAS frame format 101 is common to the COMMAND frame 71, the XFER_RDY frame 72, the DATA frame 73, and the RESPONSE frame 74.

A content that is different for the type of each frame (the type is described by a Frame Type part) is input in an Information Unit part in the frame format 101. An IPTT and a TPTT (Target Port Transfer Tag) are stored in the frame format 101. The IPTT in the frame format 101 is determined by the host 2A and the TPTT is determined by the SSD 1A.

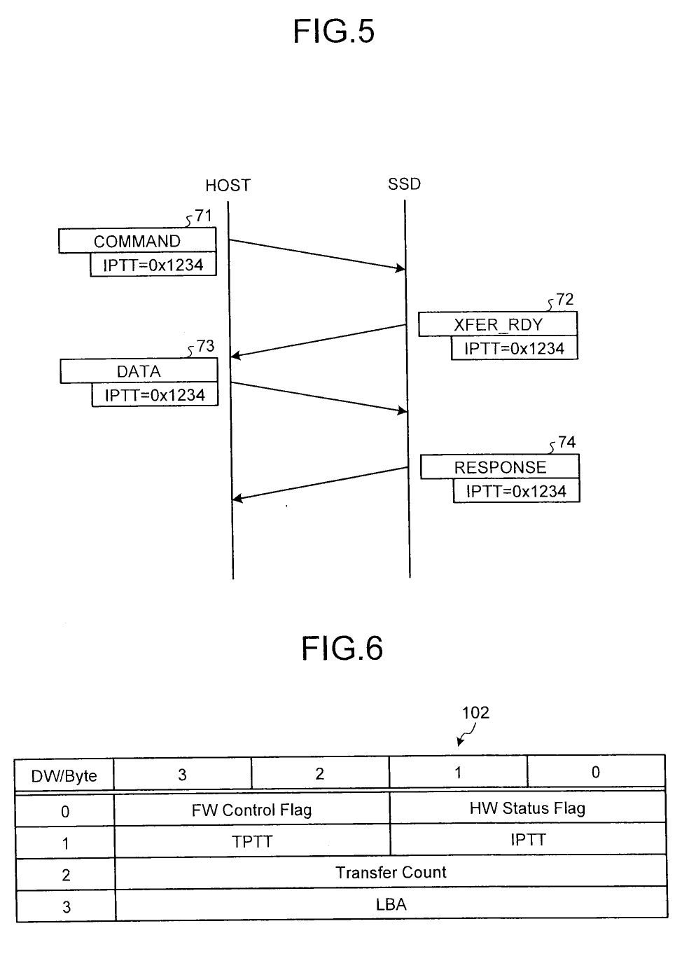

FIG. 5 is an explanatory diagram of an IPTT in the SAS write command protocol. The host 2A transmits the COMMAND frame 71 having an IPTT (for example, 0x1234) attached thereto to the SSD 1A.

When the SSD 1A receives the COMMAND frame 71 having the IPTT (for example, 0x1234) attached thereto, the SSD 1A secures a reception area. When a preparation for receiving data is completed, the SSD 1A transmits the XFER_RDY (transfer ready) frame 72 having an IPTT identical to the received IPTT attached thereto to the host 2A, thereby notifying the host 2A the fact that the preparation is completed.

With this process, the host 2A thus transmits the DATA frame 73 having an IPTT identical to the received IPTT attached thereto to the SSD 1A. The SSD 1A stores received data in the NAND 3 and then transmits the RESPONSE frame 74 having an IPTT identical to the received IPTT attached thereto to the host 2A, thereby notifying the host 2A whether a process has ended successfully.

To perform command queuing based on the SAS I/F protocol explained above, the host I/F control circuit 11A has an execution management table 102 (explained later). The execution management table 102 is registered in the host I/F control circuit 11A by the FW 16.

FIG. 6 illustrates a configuration of an execution management table. The execution management table 102 is an information table used when data requested to be written by the host 2A is managed. Information relating to a write command is stored in the execution management table 102.

In the execution management table 102, a TPTT, an LBA, a FW Control Flag, a Transfer Count (the number of transferring bytes), a HW Status Flag, and the like are managed for each IPTT. The FW 16 sets the IPTT, the LBA, and the Transfer Count in the execution management table 102 based on information extracted from a write command.

The execution management tables 102 equal to the number of commands intended to be executed simultaneously are incorporated in the host I/F control circuit 11A. For example, when two write commands need to be executed simultaneously, two execution management tables 102 are necessary.

The FW Control Flag is a flag that is set by the FW 16 to facilitate a command process by hardware (HW). A part of the FW Control Flag can be used as an area in which a Tag for identifying a command is registered. Because the Tag is used only for a command process in the SSD 1A, any information can be used as long as it is internally identifiable information. The HW Status Flag is a flag that indicates an internal state of hardware. The HW Status Flag is an area that is set by a Transport Layer 24 (explained later) after data transfer is completed.

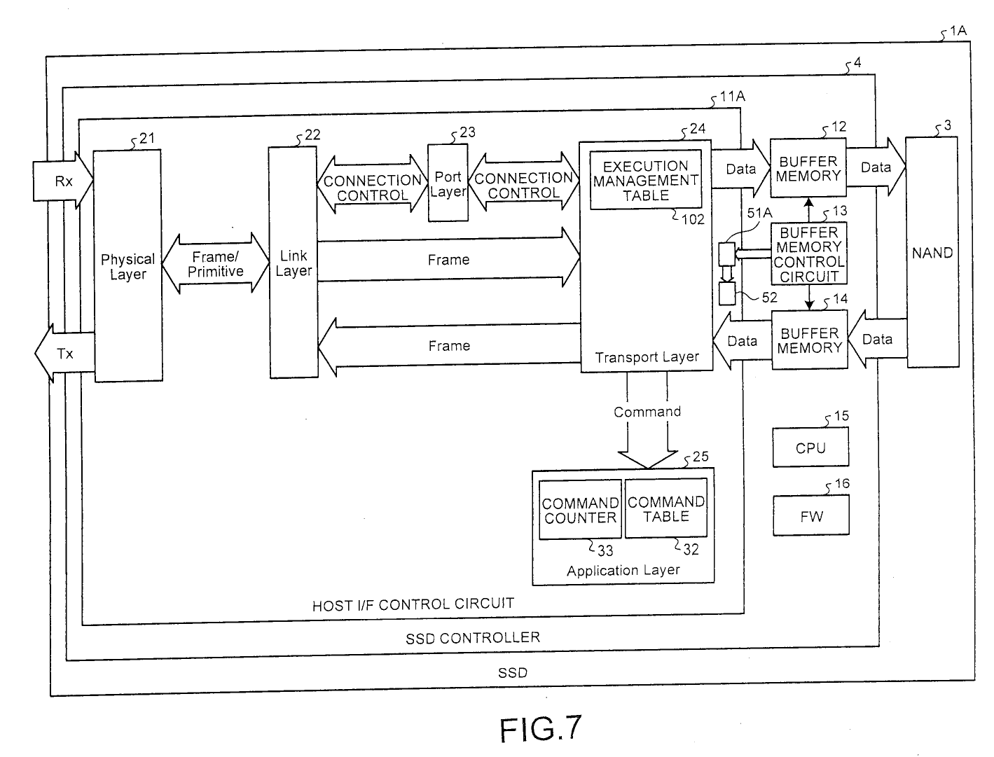

A configuration of the host I/F control circuit 11A including the execution management table 102 is explained here. FIG. 7 illustrates a configuration of a host I/F control circuit including an execution management table. Illustrations of connection between the Response setting circuit 52 and the Transport Layer 24 and connection between the Response setting circuit 52 and an Application Layer 25 are omitted in FIG. 7.

The host I/F control circuit 11A includes a Physical Layer 21, a Link Layer 22, a Port Layer 23, the Transport Layer 24, and the Application Layer 25. The Physical Layer 21 is connected to the host 2A and the Link Layer 22. The Link Layer 22 is connected to the Physical Layer 21, the Port Layer 23, and the Transport Layer 24. The Port Layer 23 is connected to the Link Layer 22 and the Transport Layer 24. The Transport Layer 24 is connected to the Link Layer 22, the Port Layer 23, and the Application Layer 25.

The Physical Layer 21 converts an electric signal input from the host 2A into a frame/primitive-based signal and inputs the converted signal to the Link Layer 22. The Physical Layer 21 also converts a frame/primitive input from the Link Layer 22 into an electric signal and outputs the electric signal to the host 2A.

The Link Layer 22 extracts a frame from a frame/primitive-mixed signal input from the Physical Layer 21 and inputs the frame to the Transport Layer 24. The Link Layer 22 also attaches a primitive to a frame input from the Transport Layer 24 and outputs the frame having the primitive attached thereto to the Physical Layer 21.

The Port Layer 23 cooperates with the Link Layer 22 and the Transport Layer 24 to direct connection control for frame transmission and reception between the Link Layer 22 and the Transport Layer 24.

The Transport Layer 24 distinguishes the type of a frame input from the Link Layer 22 and determines a frame storage destination depending on the type. For example, in a case of the Command frame 71, the Transport Layer 24 stores the Command frame 71 in a command table 32 in the Application Layer 25. In a case of the DATA frame 73, the Transport Layer 24 stores the DATA frame 73 in the buffer memory 12.

Furthermore, the Transport Layer 24 generates a frame to be transmitted based on a protocol of a currently executed command and outputs the frame to the Link Layer 22. For example, when a write command is executed, the Transport Layer 24 receives the COMMAND frame 71, then generates the XFER_RDY frame 72, and outputs the XFER_RDY frame 72 to the Link Layer 22. When the Transport Layer 24 completes reception of the DATA frame 73, the Transport Layer 24 generates the RESPONSE frame 74 and outputs the RESPONSE frame 74 to the Link Layer 22.

The Transport Layer 24 generates the XFER_RDY frame 72 based on the execution management table 102 registered by the FW 16. When the Transport Layer 24 receives the DATA frame 73, the Transport Layer 24 generates a data packet of write data based on the execution management table 102 and transmits the data packet to the buffer memory 12.

The Application Layer 25 includes registers that relate to setting of the overall SSD 1A, the command table 32, and a command counter 33. A command received from the host 2A is stored in the command table 32, and the command is read by the FW 16. For example, a command received from the host 2A and an IPTT of the command are stored in the command table 32 in a corresponding manner.

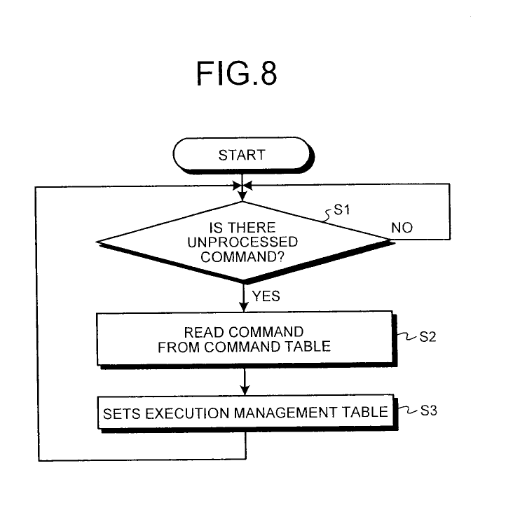

FIG. 8 is a flowchart of a process procedure of a write command process in an SSD. When the SSD 1A receives a command from the host 2A, the number of received commands is displayed in the command counter 33 in the Application Layer 25. The FW 16 monitors the command counter 33 and confirms whether an unprocessed command is present (Step S1).

When an unprocessed command is not present (No at Step S1), the FW 16 continues to monitor the command counter 33 (Step S1). When it is determined that an unprocessed command is present (Yes at Step S1), the FW 16 reads the command from the command table 32 (Step S2). The FW 16 then registers required information described in the command such as an IPTT, an LBA, and a Transfer Count in the execution management table 102.

The FW 16 also registers a Tag for identifying a write command in a FW Control Flag. The Tag can be any information as long as it is information that is internally identifiable in the SSD 1A. For example, the FW 16 can use an in-table address of the command table 32 having a command stored therein for the Tag. Alternatively, the FW 16 can use the IPTT for the Tag. In this manner, the FW 16 sets the execution management table 102 corresponding to a read command (Step S3).

Processes at Steps S2 and S3 can be performed by a dedicated circuit. In this case, a dedicated circuit that performs the processes at Steps S2 and S3 is provided in the host I/F control circuit 11A.

When the execution management table 102 is registered by the FW 16, the Transport Layer 24 generates the XFER_RDY frame 72 based on information in the execution management table 102 and transmits the XFER_RDY frame 72 to the Link Layer 22.

Thereafter, when the Transport Layer 24 receives the DATA frame 73, the Transport Layer 24 refers to the execution management table 102 and determines to which command the write data is directed based on the IPTT. The Transport Layer 24 then generates a data packet of the write data based on the information registered in the execution management table 102 and transmits the data packet to the buffer memory 12.

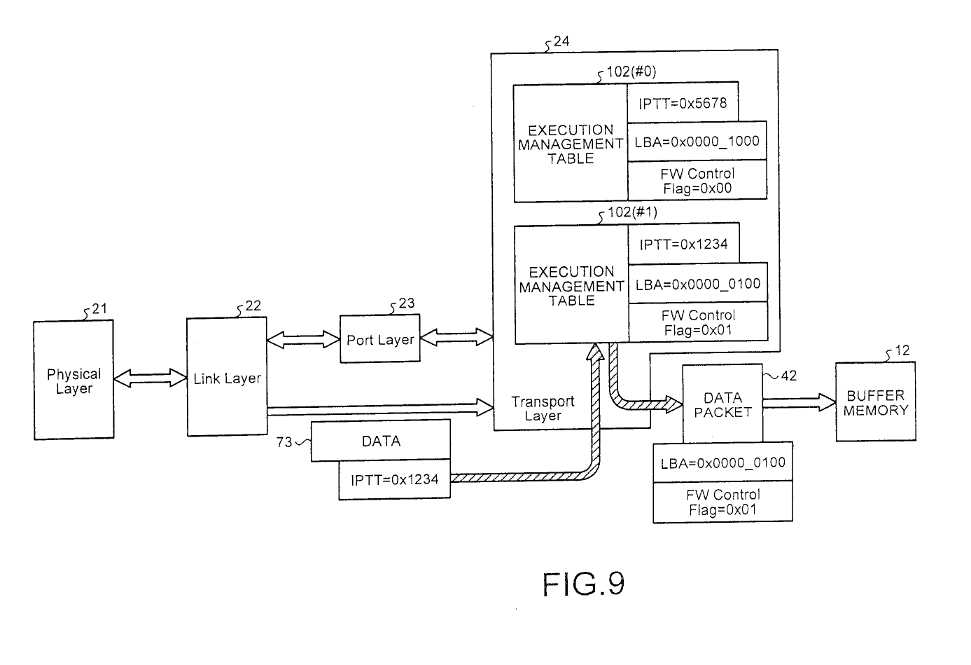

A writing operation based on an execution management table is explained here. FIG. 9 is an explanatory diagram of a writing operation based on an execution management table. A case where two execution management tables 102(#0) and 102(#1) are set in the Transport Layer 24 is explained here. IPTT=0x5678, LBA=0x0000_{—}1000, and FW Control Flag=0x00 are registered in the execution management table 102(#0). IPTT=0x1234, LBA=0x0000_{—}0100, and FW Control Flag=0x01 are registered in the execution management table 102(#1).

When the SSD 1A receives the DATA frame 73 of IPTT=0x1234, the Transport Layer 24 searches the execution management tables 102(#0) and 102(#1). Because IPTT=0x1234 is registered in the execution management table 102(#1), the Transport Layer 24 reads information from the execution management table 102(#1).

Specifically, the Transport Layer 24 reads an LBA (=0x0000_{—}0100) and an FW Control Flag (=0x01) in the execution management table 102 (#1). The Transport Layer 24 generates a data packet 42 of the DATA frame 73 based on the read information. The LBA (=0x0000_{—}0100) and the FW Control Flag (=0x01) are attached to the data packet 42, and the data packet 42 is stored in the buffer memory 12.

When the data packet 42 is stored in the buffer memory 12, the buffer memory control circuit 13 retrieves the data packet 42 from the buffer memory 12 and writes the data packet 42 to the NAND 3. When the writing is completed, the buffer memory control circuit 13 notifies the host I/F control circuit 11A the fact that the writing is completed by a signal called “Write Response”.

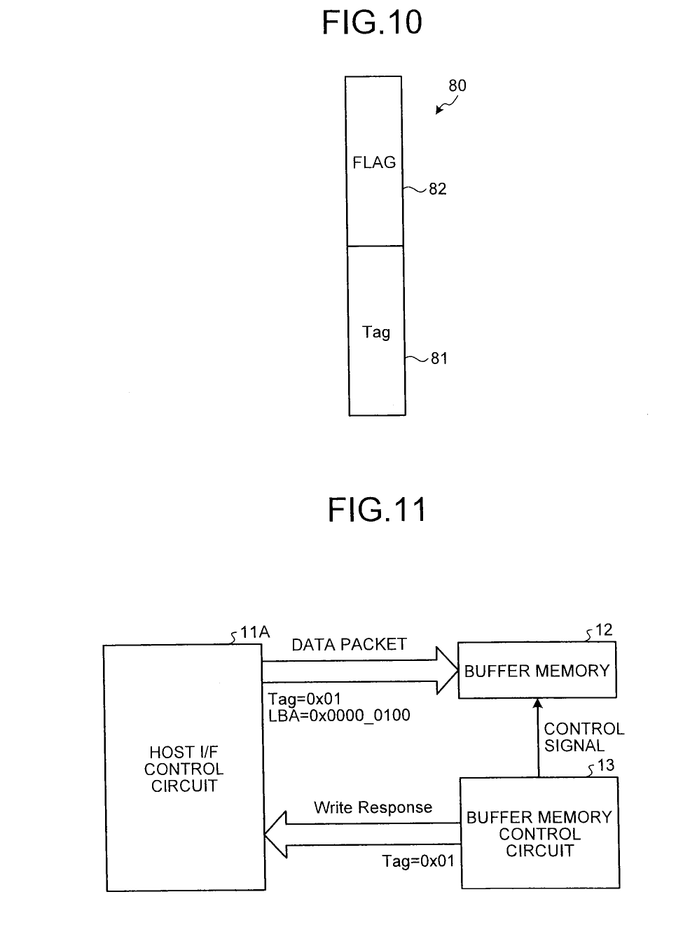

FIG. 10 illustrates a configuration of a Write Response. For example, the Write Response 80 is a 16-bit signal. The Write Response 80 includes a Tag 81 (for example, 8 bits) stored in a flag of the data packet 42 that has been written and a flag 82 (for example, 8 bits) that includes a status (GOOD/FAIL) indicating a state of writing and the like.

FIG. 11 is an explanatory diagram of a Write Response notification process. When the host I/F control circuit 11A stores the data packet 42 having an LBA (=0x0000_{—}0100) and an FW Control Flag=the Tag 81 (Tag=0x01) attached thereto in the buffer memory 12, the data packet 42 is written to the NAND 3 according to a control signal from the buffer memory control circuit 13. When the writing is completed, the buffer memory control circuit 13 generates the Write Response 80 having the Tag 81 (Tag=0x01) attached thereto and transmits the Write Response 80 to the host I/F control circuit 11A.

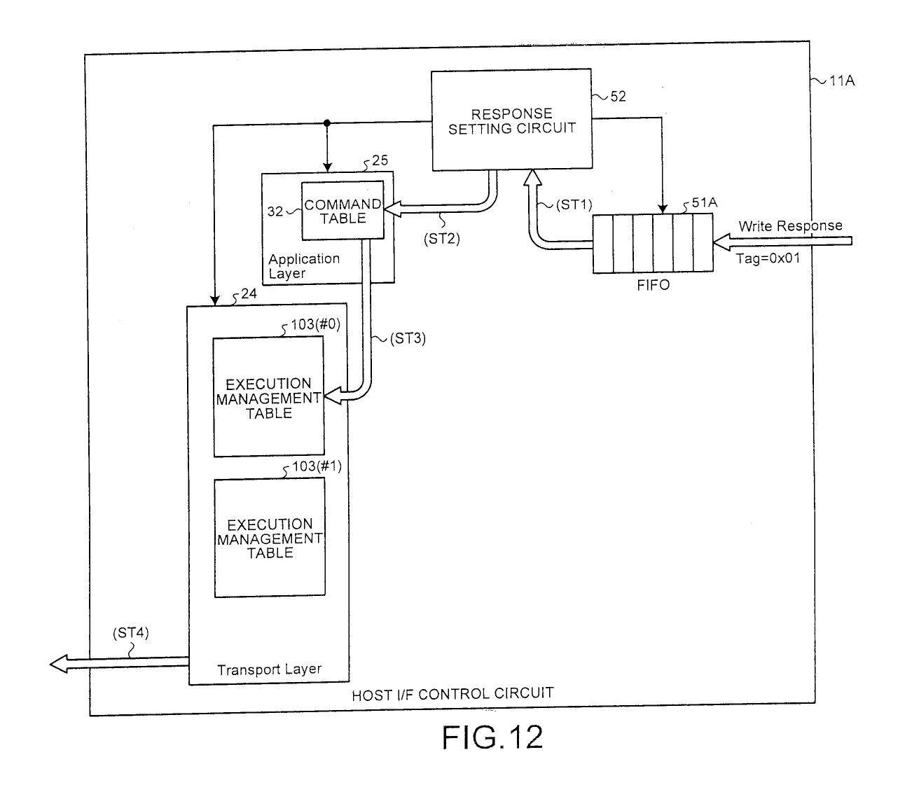

FIG. 12 is an explanatory diagram of a transmission process of a RESPONSE frame in response to a Write Response. In FIG. 12, only a part of constituent elements in the host I/F control circuit 11A is shown. In the host I/F control circuit 11A, the Response setting circuit 52 is connected to the FIFO 51A, the Application Layer 25, and the Transport Layer 24. The FIFO 51A is connected to the buffer memory control circuit 13 (the connection is not shown in FIG. 12).

The Write Response 80 transmitted from the buffer memory control circuit 13 is stored in the FIFO 51A in the host I/F control circuit 11A. The Response setting circuit 52 in the host I/F control circuit 11A extracts the Write Response 80 from the FIFO 51A (ST1).

The Response setting circuit 52 searches the command table 32 to determine to which write command the extracted Write Response 80 is directed by using the Tag 81 in the Write Response 80 as an index. In other words, the Response setting circuit 52 searches the command table 32 based on the Tag in the Write Response 80, thereby finding a write command and an IPTT corresponding to the Write Response 80 in the command table 32 (ST2).

In the command table 32, an IPTT and a command are stored in various address positions (in-table addresses) in a corresponding manner. Therefore, the Response setting circuit 52 can search a command even when an IPTT is used for the Tag 81. However, when an in-table address of the command table 32 is used for the Tag 81, the search becomes easier compared to the case of the IPTT.

The Response setting circuit 52 specifies a write command corresponding to the Write Response 80 and then sets the execution management tables 103(#0) and 103(#1) for Response (ST3). At this time, the Response setting circuit 52 registers information an IPTT extracted from the command table 32 and other required information (information indicating from which host the command is received and the like) in the execution management tables 103(#0) and 103(#1) for Response.

For example, an execution management table that corresponds to Tag=0x00 is the execution management table 103(#0), and an execution management table that corresponds to Tag=0x01 is the execution management table 103(#1). In this case, when the Tag 81 in the Write Response 80 is Tag=0x00, the Response setting circuit 52 sets the execution management table 103(#0) corresponding to Tag=0x00. Thereafter, in the host I/F control circuit 11A, the Transport Layer 24 transmits the RESPONSE frame 74 to the host 2A based on the execution management table 103(#0) (ST4).

As explained above, according to the first embodiment, because the host I/F control circuit 11A includes the Response setting circuit 52, high-speed processing can be performed with respect to a write command.

### Second Embodiment

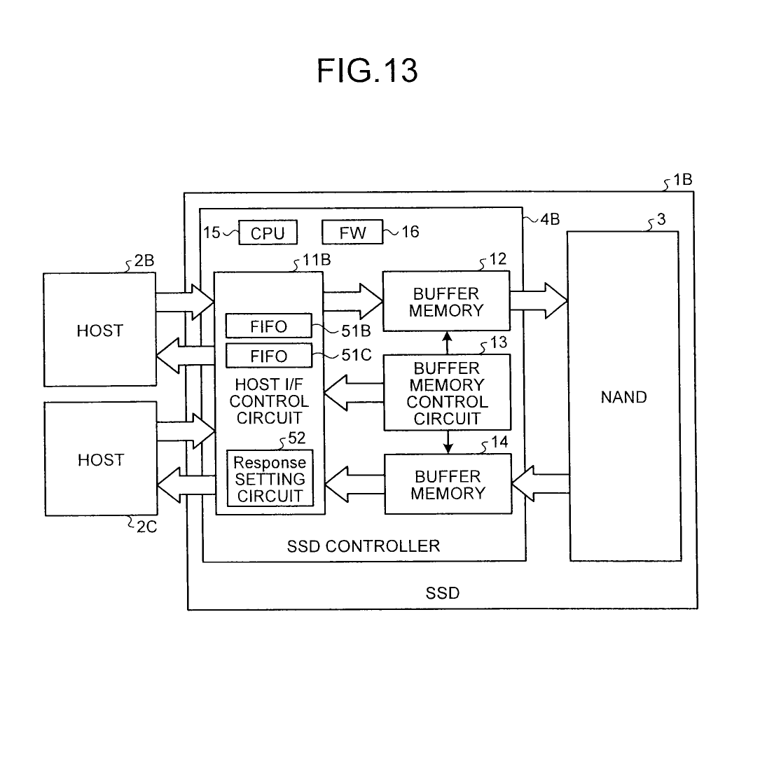

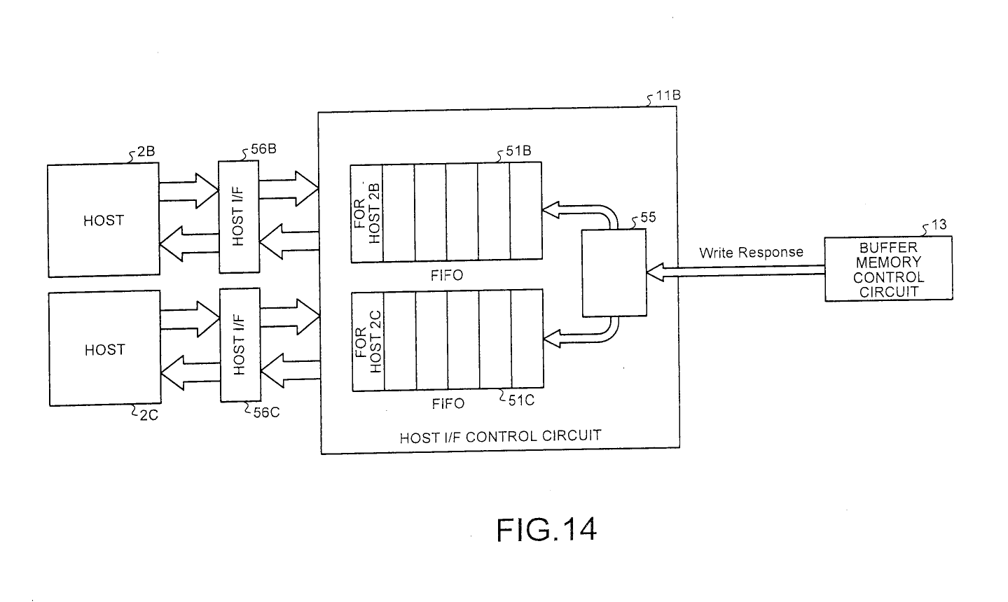

Next, a second embodiment is explained with reference to FIGS. 13 and 14. In the second embodiment, a plurality of hosts is connected to one SSD, and FIFOs equal to the number of the hosts are provided in the SSD.

FIG. 13 illustrates a configuration of a memory system according to the second embodiment. Among the constituent elements in FIG. 13, constituent elements having functions identical to those of the SSD 1A according to the first embodiment shown in FIG. 1 are denoted by like reference signs and redundant explanations thereof will be omitted.

In the SAS I/F, it is possible to connect a plurality of host computers to one storage device. The present embodiment explains a case where hosts 2B and 2C are connected to an SSD 1B serving as a storage device.

The SSD 1B is a device that receives a write command from the hosts 2B and 2C and performs a data writing process in response to the write command. The SSD 1B includes an SSD controller 4B and the NAND 3. For example, the SSD controller 4B is constituted by a semiconductor chip such as an LSI.

The SSD controller 4B controls data transfer between the host 2B and the NAND 3, data transfer between the host 2C and the NAND 3, and the like. The SSD controller 4B includes a host I/F control circuit 11B, the buffer memories 12 and 14, the buffer memory control circuit 13, the CPU 15, and the FW 16. The host I/F control circuit 11B according to the present embodiment includes a FIFO 51B used for the Write Response 80 to the host 2B, a FIFO 51C used for the Write Response 80 to the host 2C, and a distribution circuit 55 (explained later) with reference to FIG. 14.

The SSD 1B is connected to two different hosts 2B and 2C independently. Therefore, from the standpoint of each of the hosts 2B and 2C, it is desirable that the SSD 1B is operated independently. That is, it is desirable that data transfer between the host 2C and the SSD 1B is not influenced by a data transfer state between the host 2B and the SSD 1B. Similarly, it is desirable that data transfer between the host 2B and the SSD 1B is not influenced by a data transfer state between the host 2C and the SSD 1B.

In the SSD 1B, when storage of write data transmitted from the hosts 2B and 2C to the NAND 3 is completed, the host I/F control circuit 11B receives the Write Response 80 from the buffer memory control circuit 13.

In this case, when only one FIFO is provided in the host I/F control circuit 11B, RESPONSE transmission to one host (for example, the host 2C) may be delayed by a state of the other host (for example, the host 2B). For example, communication with the host 2B is delayed by a certain failure, the Write Response 80 for the host 2B stored in the head of the only one FIFO cannot be collected. In such a state, the Write Response 80 for the host 2C cannot be collected from the FIFO. As a result, the RESPONSE frame 74 cannot be transmitted to the host 2C because of an event occurred on the side of the host 2B.

To prevent occurrences of such a state, according to the present embodiment, while the buffer memory control circuit 13 is connected to the host I/F control circuit 11B on a one-to-one basis, FIFOs receiving the Write Response 80 equal to the number of host computers that are possibly connected simultaneously are incorporated in the memory system.

Specifically, the FIFOs 51B and 51C equal to the number (two) of the hosts 2B and 2C that are possibly connected simultaneously are arranged in the SSD 1B as FIFOs receiving the Write Response 80. Further, host I/Fs equal to the number of the hosts 2B and 2C are also arranged in the SSD 1B.

FIG. 14 is an explanatory diagram of a FIFO in a host I/F control circuit according to the second embodiment. The host I/F control circuit 11B includes the FIFOs 51B and 51C and the distribution circuit 55. The distribution circuit 55 is connected to the buffer memory control circuit 13. The distribution circuit 55 is also connected to the FIFOs 51B and 51C. A host I/F 56B included in the SSD 1B is connected to the host 2B and the host I/F control circuit 11B. A host I/F 56C included in the SSD 1B is connected to the host 2C and the host I/F control circuit 11B.

In the host I/F control circuit 11B, the distribution circuit 55 arranged in a preceding stage of the FIFOs 51B and 51C receives the Write Response 80 transmitted from the buffer memory control circuit 13. The distribution circuit 55 then determines to which of the hosts 2B and 2C the Write Response 80 is directed based on the Write Response 80, and stores the Write Response 80 in a FIFO according to a result of determination. Specifically, the distribution circuit 55 stores the Write Response 80 to the host 2B in the FIFO 51B as the Write Response 80 for the host 2B and the Write Response 80 to the host 2C in the FIFO 51C as the Write Response 80 for the host 2C.

For example, the host I/F control circuit 11B registers information in the execution management table 102 at the time of data writing to the NAND 3. At this time, the FW 16 registers information (host identification information) that can identify from which of the hosts 2B and 2C the write data is requested in a specific bit in a FW Control Flag. Further, the host I/F control circuit 11B stores the host identification information registered in the specific bit by the FW 16 in a flag of a data packet. The buffer memory control circuit 13 then stores the host identification information in the flag 82 of the Write Response 80. The SSD 1B can distribute the Write Response 80 to either the FIFO 51B or the FIFO 510 by other methods than this method.

When the Write Response 80 for the host 2B is stored in the FIFO 51B, the RESPONSE frame 74 is transmitted via the host I/F 56B to the host 2B. When the Write Response 80 for the host 2C is stored in the FIFO 51C, the RESPONSE frame 74 is transmitted via the host I/F 56C to the host 2C.

As explained above, according to the second embodiment, because the host I/F control circuit 11B includes FIFOs equal to the number of hosts that are possibly connected simultaneously, the SSD 1B can be operated independently for each of the hosts.

### Third Embodiment

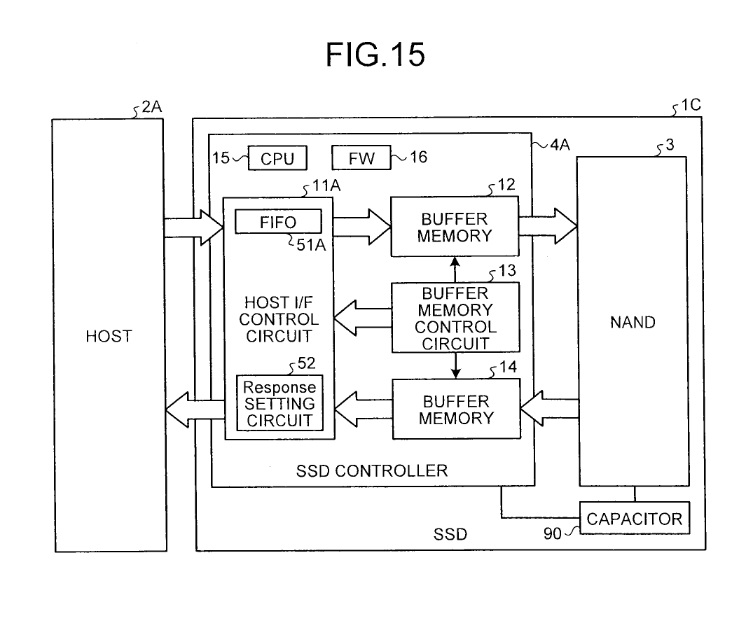

Next, a third embodiment is explained with reference to FIG. 15. According to the third embodiment, a capacitor is provided in an SSD so that even when a power supply is shut down during data writing, an operation of the data writing can be continued.

FIG. 15 illustrates a configuration of a memory system according to the third embodiment. Among the constituent elements in FIG. 15, constituent elements having functions identical to those of the SSD 1A according to the first embodiment shown in FIG. 1 are denoted by like reference signs and redundant explanations thereof will be omitted.

An SSD 10 includes a power-supply holding unit (a charge accumulation unit) such as a capacitor 90, in addition to constituent elements of the SSD 1A. The capacitor 90 is connected to the SSD controller 4A and the NAND 3. The capacitor 90 accumulates charges that can operate the SSD controller 4A and the NAND 3. In the SSD 10, when a power supply is shut down during data writing, an operation of the data writing by the SSD controller 4A is continued by the charges accumulated in the capacitor 90.

In the first embodiment, after write data is stored in the NAND 3, the Write Response 80 is transmitted to the host I/F control circuit 11A. On the other hand, according to the SSD 10 of the present embodiment, the buffer memory control circuit 13 transmits the Write Response 80 to the host I/F control circuit 11A before write data is stored in the NAND 3 (for example, when write data is stored in the buffer memory 12).

Because the capacitor 90 is incorporated in the SSD 10, even when a power supply is shut down during data writing, an operation of the data writing can be continued by charges accumulated in the capacitor 90. Therefore, before data is stored in the NAND 3, the buffer memory control circuit 13 can transmit the Write Response 80 to the host I/F control circuit 11A. As a result, the host I/F control circuit 11A can transmit the RESPONSE frame 74 to the host 2A in a short time after receiving the write data.

According to the third embodiment, because the SSD 10 includes the capacitor 90, the SSD 10 can transmit a response to the RESPONSE frame 74 to the host 2A in a short time after receiving write data.

As described above, according to the first to third embodiments, it is possible to realize high-speed processing with respect to a write command.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a command table that stores therein a write command received from a host;
a nonvolatile memory that stores therein write data corresponding to the write command received from the host;
a response setting circuit that creates a management table that corresponds to the write command in the command table;
a transport layer that generates a response frame based on the management table; and
a physical layer that transmits the response frame to the host.

2. The memory system according to claim 1, wherein first identification information that is attached to the write command and identifies the write command with respect to the host and the write command are stored in the command table in a corresponding manner,
the response setting circuit creates the management table including the first identification information,
the transport layer generates the response frame including the first identification information, and
the physical layer transmits the response frame including the first identification information to the host.

3. The memory system according to claim 2, further comprising:
a write buffer that temporarily stores therein the write data; and
a buffer memory control circuit that controls the write buffer and that, when writing of the write data from the write buffer to the nonvolatile memory is completed, generates a write response including information indicating completion of the writing and second identification information identifying the write command in the memory system, wherein
the response setting circuit extracts a write command corresponding to the write response from the command table based on the second identification information and creates the management table according to the extracted write command.

4. The memory system according to claim 3, wherein the buffer memory control circuit uses an address as the second identification information, the address indicating an area in the command table in which the write command is stored.

5. The memory system according to claim 3, further comprising:
a first host I/F that is connected to a first host;
a second host I/F that is connected to a second host;
a first FIFO that temporarily stores therein a first write response used for generating a response frame to be transmitted from the first host I/F to the first host among write responses transmitted from the buffer memory control circuit;
a second FIFO that temporarily stores therein a second write response used for generating a response frame to be transmitted from the second host I/F to the second host among write responses transmitted from the buffer memory control circuit; and
a distribution circuit that receives the first and second write responses transmitted from the buffer memory control circuit and transmits the first write response to the first FIFO and the second write response to the second FIFO based on third identification information, the third identification information being included in the received write response and identifying a host to which the received write response is sent.

6. The memory system according to claim 1, further comprising a power-supply holding unit that holds charges for continuously performing an operation of a data writing process when a power supply is shut down during the data writing process, wherein
the buffer memory control circuit generates the write response before the nonvolatile memory completes storage of the write data.

7. The memory system according to claim 6, wherein the physical layer transmits the response frame to the host before the nonvolatile memory completes storage of the write data.

8. The memory system according to claim 6, wherein the buffer memory control circuit generates the write response when the write data is temporarily stored in the write buffer.

9. The memory system according to claim 3, wherein
the write command is based on a SAS standard, and
the buffer memory control circuit uses an IPTT included in the write command as the first identification information.

10. A control method of a memory system comprising:
storing a write command received from a host in a command table;
storing write data corresponding to the write command received from the host in a nonvolatile memory;
generating a management table that corresponds to the write command by a response setting circuit in the command table;
generating a response frame by a transport layer based on the management table; and
transmitting the response frame to the host by a physical layer.

11. The control method of a memory system according to claim 10, wherein
storing first identification information that is attached to the write command and identifies the write command with respect to the host and the write command in the command table in a corresponding manner,
creating the management table including the first identification information by the response setting circuit,
generating the response frame including the first identification information by the transport layer, and
transmitting the response frame including the first identification information to the host by the physical layer.

12. The control method of a memory system according to claim 11, wherein
storing the write data temporarily in a write buffer,
controlling the write buffer by a buffer memory control circuit,
generating a write response including information indicating completion of the writing and second identification information identifying the write command in the memory system by the buffer memory control circuit, when writing of the write data from the write buffer to the nonvolatile memory is completed, and
the response setting circuit extracts a write command corresponding to the write response from the command table based on the second identification information and creates the management table according to the extracted write command.

13. The control method of a memory system according to claim 12, wherein the buffer memory control circuit uses an address as the second identification information, the address indicating an area in the command table in which the write command is stored.

14. The control method of a memory system according to claim 12, wherein
connecting a first host I/F to a first host,
connecting a second host I/F to a second host,
storing a first write response temporarily by a first FIFO, the first write response is used for generating a response frame to be transmitted from the first host I/F to the first host among write responses transmitted from the buffer memory control circuit,
storing a second write response temporarily by a second FIFO, the second write response is used for generating a response frame to be transmitted from the second host I/F to the second host among write responses transmitted from the buffer memory control circuit,
receiving the first and second write responses transmitted from the buffer memory control circuit by a distribution circuit, and
transmitting the first write response to the first FIFO and the second write response to the second FIFO by the distribution circuit based on third identification information, the third identification information being included in the received write response and identifying a host to which the received write response is sent.

15. The control method of a memory system according to claim 10, wherein
holding charges for continuously performing an operation of a data writing process when a power supply is shut down during the data writing process by a power-supply holding unit, and
the buffer memory control circuit generates the write response before the nonvolatile memory completes storage of the write data.

16. The control method of a memory system according to claim 15, wherein the physical layer transmits the response frame to the host before the nonvolatile memory completes storage of the write data.

17. The control method of a memory system according to claim 15, wherein the buffer memory control circuit generates the write response when the write data is temporarily stored in the write buffer.

18. The control method of a memory system according to claim 12, wherein
the write command is based on a SAS standard, and
the buffer memory control circuit uses an IPTT included in the write command as the first identification information.

19. A controller comprising:
a command table that stores therein a write command received from a host;
a response setting circuit that creates a management table that corresponds to the write command in the command table;
a transport layer that transmits write data corresponding to the write command received from the host to a nonvolatile memory side and generates a response frame based on the management table; and
a physical layer that transmits the response frame to the host.

20. The controller according to claim 19, wherein
first identification information that is attached to the write command and identifies the write command with respect to the host and the write command are stored in the command table in a corresponding manner,
the response setting circuit creates the management table including the first identification information,
the transport layer generates the response frame including the first identification information, and
the physical layer transmits the response frame including the first identification information to the host.
